(19) United States
(12) Patent Application Publication
(10) Pub. No.: US 2026/0269125 A1
(43) Pub. Date: Sep. 10, 2026

(54) Method for producing a capacitor element comprising a dielectric ceramic film, slip for producing a dielectric ceramic film, and capacitor element comprising a dielectric ceramic film

(71) Applicant: Technische Universität Darmstadt, Darmstadt (DE)

(72) Inventors: Maximilian GEHRINGER, Wolfratshausen (DE); An-Phuc HOANG, Darmstadt (DE); Till FRÖMLING, Darmstadt (DE)

(73) Assignee: Technische Universität Darmstadt, Darmstadt (DE)

(21) Appl. No.: 18/871,712

(22) PCT Filed: Jun. 13, 2023
(86) PCT No.: PCT/EP2023/065856

§ 371 Date: Dec. 4, 2024

(30) Foreign Application Priority Data
Jun. 14, 2022 (DE) 10 2022 114 964.1

(51) Int. Cl. H01G 4/12; C04B 35/468; C04B 35/626; C04B 41/00; H01G 4/30; H01G 13/04

(52) U.S. Cl. CPC H01G 4/1218; C04B 35/468; C04B 35/6261; C04B 35/6264; C04B 41/0072; H01G 4/30; H01G 13/04; C04B 2235/3201; C04B 2235/3208; C04B 2235/3215; C04B 2235/3217; C04B 2235/3232; C04B 2235/3244; C04B 2235/3298

(57) ABSTRACT

Producing a capacitor element includes producing a slip from a ceramic powder and an organic medium. For the ceramic powder, at least the oxides Bi₂O₃, TiO₂, ZrO₂ and Al₂O₃ and at least the carbonates Na₂CO₃, BaCO₃ and CaCO₃ or precursors of the oxides and/or carbonates are used in a stoichiometric ratio in order to synthesize (1−x)[0.8 (0.94 Na_{0.5}Bi_{0.5}TiO₃·0.06 BaTiO₃)·0.2 CaZrO₃]·x BiAlO₃, where x=0.5, 1, 1.5, 2, 4 and 8 mol %. The slip is cast as a film. An electrode (10) is applied to the cast film. The cast film provided with an electrode (10) is sintered at an elevated temperature. The organic medium has at least one liquid solvent which contains at least 1-butanol, at least one plasticiser which contains acetyl tributyl citrate, at least one dispersing agent, and at least one binder.

### CROSS-REFERENCE TO RELATED APPLICATION

This application is a national stage application, filed under 35 U.S.C. § 371, of International Patent Application PCT/EP2023/065856, filed on Jun. 13, 2023, which claims the benefit of German Patent Application DE 10 2022 114 964.1, filed on Jun. 14, 2022.

### BACKGROUND

A capacitor is a passive electronic component which is installed in virtually all electronic applications. Capacitors are used in aerospace technology, the automotive industry, or also portable entertainment electronics. A capacitor can consist of at least one capacitor element and of further connections and lines required for contacting the capacitor element. The capacitor element comprises a dielectric medium in the form of a dielectric film, and an electrode arranged on the dielectric film. In this case, any thin layer which is suitable, with respect to dimensions, for shielding, as a dielectric component, an electrode of the capacitor element in such a way that electrical charge and the associated energy can be statically stored in an electric field of a capacitor, with the aid of said capacitor element, is considered a film. In this case, as part of an electric circuit, capacitor elements should exhibit properties that are as stable as possible, over a large temperature range and high applied voltages, wherein at the same time ever smaller dimensions of the capacitor elements at constant or improved performance are required. Furthermore, the reliability and durability of said passive electronic components are also subject to high requirements.

Frequently, capacitor elements having an aluminium film or a thin aluminium oxide film or a polymer film as the dielectric film are used. On account of the structure and properties of said dielectric films, such passive components can be used only up to certain temperature upper limits, which usually do not exceed 120° C. Above these temperature upper limits, usually dielectric ceramic films are used. This type of capacitor element comprises one or more dielectric ceramic films, as the dielectric medium, instead of the temperature-sensitive polymer films or aluminium films.

In order to shift the temperature upper limit to temperatures far above 120° C., a plurality of systems are known from the prior art. In order to meet the requirements of high temperature capacitor elements, for example Na_{0.5}Bi_{0.5}TiO₃ (NBT)- or BaTiO₃ (BT)-based systems or their solid solutions are considered promising materials (Ren, P., He, J., Sun, L., Frömling, T., Wan, Y., Yang, S., Zhao, G. (2019), Journal of the European Ceramic Society, 39(14), 4160-4167). Owing to a complex defect chemistry of NBT-based materials and their solutions, however, hitherto no material could be found which has a stable capacitance, in the industrially important temperature range of −50° C. to ≥300° C., in the case of a small dielectric loss tan δ of less than 2% (Zeb, A., & Milne, S. J. (2015), Journal of Materials Science: Materials in Electronics, 26(12), 9243-9255). Recently, material systems have become known which can fulfil the temperature ranges set by the industry. These include the material system (1−x)[0.8 (0.94Na_{0.5}Bi_{0.5}TiO₃·0.06 BaTiO₃)·0.2 CaZrO₃]·x BiAlO₃. This material system comprises the oxides sodium bismuth titanate, barium titanate, calcium zirconate and bismuth aluminate (Hoang, A. P., Steiner, S., Yang, F., Li, L., Sinclair, D. C., & Frömling, T. (2021), Journal of the European Ceramic Society, 41(4), 2587-2595).

Capacitor elements are usually produced from a slip. A slip is understood to be a mixture of a ceramic powder and an organic medium. For this purpose, the ceramic powder can comprise air-stable educts, such as oxides and/or carbonates and the mixtures thereof, which—weighed out in a suitable stoichiometric ratio to one another—can be sintered in the context of a solid-state reaction to form the desired dielectric ceramic film.

The organic medium allows for optimal mixing of the individual components of the ceramic powder before sintering. After its production, the slip can be cast, in a film-casting step, as a thin film.

The properties of the sintered slip are largely predetermined by the composition of the slip, and also by the method steps performed for its production, as well as the parameters used during the method, and thus determine the final properties of the capacitor element to a significant extent.

### SUMMARY

The disclosure relates to a method for producing a capacitor element comprising a dielectric ceramic film, wherein in a slip production step, a slip is produced from a ceramic powder and an organic medium, wherein for the ceramic powder, at least the oxides Bi₂O₃, TiO₂, ZrO₂ and Al₂O₃ and at least the carbonates Na₂CO₃, BaCO₃ and CaCO₃ or respective precursors of the oxides and/or carbonates are used in a stoichiometric ratio in order to synthesize (1−x)[0.8 (0.94 Na_{0.5}Bi_{0.5}TiO₃·0.06 BaTiO₃)·0.2 CaZrO₃]·x BiAlO₃, where x=0.5, 1, 1.5, 2, 4 and 8 mol %, and wherein the slip is cast as a film in a film-casting step, and wherein an electrode is applied to the cast film in an electrode-application step, and wherein the cast film provided with an electrode is sintered in a sintering step at an elevated temperature in order to remove organic material from a structure and to convert the cast film into the dielectric ceramic film, wherein the dielectric ceramic film comprises at least (1−x)[0.8 (0.94 Na_{0.5}Bi_{0.5}TiO₃·0.06 BaTiO₃)·0.2 CaZrO₃]·x BiAlO₃, where x=0.5, 1, 1.5, 2, 4 and 8 mol %.

The disclosure also relates to a slip for producing a dielectric ceramic film, wherein the slip comprises a ceramic powder and an organic medium, wherein the ceramic powder comprises at least the oxides Bi₂O₃, TiO₂, ZrO₂ and Al₂O₃ and at least the carbonates Na₂CO₃, BaCO₃ and CaCO₃ or respective precursors of the oxides and/or carbonates.

The disclosure furthermore also relates to a capacitor element comprising a dielectric ceramic film which comprises at least (1−x)[0.8 (0.94 Na_{0.5}Bi_{0.5}TiO₃·0.06 BaTiO₃)·0.2 CaZrO₃]·x BiAlO₃, where x=0.5, 1, 1.5, 2, 4 and 8 mol %, wherein the dielectric ceramic film comprises an electrode, and wherein the ceramic film is produced from a slip, wherein the slip comprises a ceramic powder and an organic medium.

An object of the disclosure is considered to be that of improving the method known from the prior art for producing a capacitor element comprising a dielectric ceramic film, the slip for producing a dielectric ceramic film, and the capacitor element comprising a dielectric ceramic film.

This object is achieved by the method for producing a capacitor element comprising a dielectric ceramic film, wherein the organic medium has at least one liquid solvent which contains at least 1-butanol, at least one plasticiser which contains acetyl tributyl citrate, at least one dispersing agent, and at least one binder.

A capacitor element comprising a dielectric ceramic film made of the slip can be constituted, having particularly advantageous properties. In this case, the material system optimised by this synthesis stands out in particular for use at elevated temperatures or in the case of elevated temperature fluctuations, as well as high electric voltages during operation. Furthermore, in the temperature range considered it offers a significant energy storage density and significant efficiency with a simultaneously low dielectric loss.

In this case, the obtained properties of the dielectric ceramic film are provided in particular by the production method for the slip. Preferably, the oxides Bi₂O₃, TiO₂, ZrO₂ and Al₂O₃ and the carbonates Na₂CO₃, BaCO₃ and CaCO₃ are weighed in a stoichiometric ratio to one another that is such that the slip can be sintered in the sintering step to form (1−x)[0.8 (0.94 Na_{0.5}Bi_{0.5}TiO₃·0.06 BaTiO₃)·0.2 CaZrO₃]·x BiAlO₃. In this case, the optimum properties set out are present in the range of x=0.5, 1, 1.5, 2, 4 and 8 mol %. Particularly preferably, however, the ceramic powder is weighed in such that after the sintering 0.995[0.8 (0.94 Na_{0.5}Bi_{0.5}TiO₃·0.06 BaTiO₃)·0.2 CaZrO₃]·0.005 BiAlO₃ results. In this case, the dielectric ceramic film produced from this slip exhibits a stable relative permittivity, within −83° C. to 550° C., having a fluctuation of just ≤15% and a maximum value of 630 at 1 kHz. The dielectric loss tan δ≤0.02 is stable in a range of −68° C. to 391° C., resulting in a maximum range of use of −68° C. to 391° C. for use as a capacitor element.

As already discussed, the composition and the ratios of the materials used in the slip are decisive for the properties of the dielectric ceramic film constituted therefrom. In the slip production step, in addition to the ceramic powder the organic medium is added. In this case, the organic medium comprises at least one liquid solvent, which contains at least 1-butanol. The use of 1-butanol compared with the solvents known from the prior art such as ethanol and/or butane-2-one offers the advantage that 1-butanol evaporates more slowly compared with the previously mentioned solvents, such that the ceramic powder has sufficient time, after being mixed with the organic medium, for sedimentation and for forming a packing of the individual particles of the ceramic powder that is as dense as possible or the most dense. However, in addition to 1-butanol other solvents can also be used, and in particular in this case such solvents which are present in liquid in the temperature range of the synthesis, i.e. at room temperature, and have a similar evaporation speed to 1-butanol at room temperature. The rapid evaporation of ethanol or also of butane-2-one means that on the one hand cavities may result due to the resulting limited sedimentation, and on the other hand non-uniform packing and thus an inhomogeneous distribution can lead to an increased occurrence of secondary phases after the sintering step. In this case, such secondary phases can decisively weaken the properties of the final dielectric ceramic film, since occurring secondary phases cannot be removed or can be removed only with increased effort.

Advantageously, acetyl tributyl citrate is used as the plasticiser. In this case, the plasticiser has the task of keeping the cast film flexible after casting. For example polyethylene glycol is known from the prior art for use as a plasticiser. In contrast to the hygroscopic polyethylene glycol, acetyl tributyl citrate is not hydroscopic. During the production of the slip, or also during the storage time, in the case of use of a hygroscopic plasticiser water may accumulate on the plasticiser itself, even if only superficially, or also penetrate into the depth of the structure of the slip. Water molecules that have accumulated on the surface or are present in the structure can evaporate during the sintering step of the slip, as a result of which they leave behind pores when leaving the structure, which pores on the one hand locally interfere with the structure at this point, but on the other hand can also change and reduce the final density of the component and thus the desired properties. In contrast, acetyl tributyl citrate does not accumulate significant amounts of water, as a result of which the final density of the component is not significantly impaired by the use of this plasticiser. In addition to the use of acetyl tributyl citrate, other plasticisers can also be used, which also do not have hygroscopic properties. Furthermore, in contrast to for example the widespread phthalates, the use of acetyl tributyl citrate can constitute a biologically more harmless and thus more environmentally friendly decision.

A dispersing agent is understood to be a usually molecule-like compound which is capable of preventing agglomeration, over a certain time period, due to accumulation on a dissolved particle, this case the particles of the ceramic powder. This is achieved in that the all-round agglomeration of the dispersing agent sterically prevents the agglomeration of the individual particles, in that the molecules of the dispersing agent bind to a first particle and thus can prevent the direct agglomeration, i.e. the direct contact of a further second particle with the first particle. A plurality of dispersing agents is known from the prior art, including for example oleic acids and/or the derivatives thereof. However, oleic acids and/or the derivatives thereof are only slightly resistant to oxidation under normal conditions. The decomposition of these oleic acids and/or derivatives that are not oxidation-resistant results in decomposition products which can decisively limit the final density of the cast film, as a result of which a change in the properties of the final dielectric ceramic film can be caused. For this reason, dispersing agents are preferably used which are characterised by extremely high stability and which do not attach the cast film during storage thereof, and/or cannot be decomposed themselves by outside influences. The dispersing agent therefore advantageously has a structure which effectively supports the separation of individual particles in the slip or in a slurry, for example by a particularly sterically demanding arrangement of the chains and/or side chains. Furthermore, the dispersing agent used should, as already mentioned, be thermodynamic and also chemically resistant. Furthermore, the dispersing agent preferably binds as strongly as possible to the individual ceramic particles, in order not to be able to be prematurely displaced from the surface thereof. In this case, tests have shown that in particular Solsperse® M387 by the manufacturer Lubrizol can advantageously be used.

Due to its structure, the binder decisively specifies the arrangement of the ceramic particles during the production of the slip, in the slip production step, in which the components of the slip are arranged relative to one another by means of the binder. In this case, the binder is combusted during the sintering process, i.e. oxidised into volatile gaseous components and thus removed from the structure. Due to its three-dimensional structure, the binder specifies the arrangement and thus the position of the individual particles relative to one another. After the sintering process, all that remains is the dielectric ceramic film produced from the ceramic powders, the structure of which has been largely specified by the binder. Preferably, binders can be used which, on account of their size and their property bind to the particle surface and can thus also function as dispersing agents. In this case, in particular PVB Mowital® LP BX860 by the manufacturer Kuraray Europe GmbH has been found to be advantageous as a binder.

The organic medium, composed of the liquid solvent at least containing 1-butanol, at least one plasticiser at least containing acetyl tributyl citrate, at least one dispersing agent, and at least one binder, can be mixed, in the slip production step, together with the ceramic powder, until sufficiently homogeneous mixing is achieved. The ceramic powder itself can be produced from the mentioned oxides and carbonates. It is possible for the oxides and/or carbonates to be mixed in advance to form a mixture, before they are combined with the organic medium, or the oxides and carbonates can be added to the organic medium at the same time and mixed.

Furthermore, it is optionally envisaged that the carbonates and/or oxides are not used directly, but rather that precursors of the oxides and/or carbonates are used, which, in the sintering step during the reaction to (1−x)[0.8 (0.94 Na_{0.5}Bi_{0.5}TiO₃·0.06 BaTiO₃)·0.2 CaZrO₃]·x BiAlO₃ for example include the oxides according to the invention as intermediate steps. Furthermore, the carbonates and/or oxides can be produced from precursors, before being added to the organic medium in the slip production step. For example, ZrO₂ can be obtained from ZrSiO₄ at elevated temperatures.

In order to achieve the desired composition, the oxides and/or carbonates used, and/or their precursors, should preferably be used at the highest possible degree of purity, including in particular a purity of ≥99.975% for Bi₂O₃, ≥99.6% for TiO₂, ≥99.5% for ZrO₂, ≥99.95% for Al₂O₃, ≥99.5% for Na₂CO₃, ≥99.8% for BaCO₃ and ≥99.5% for CaCO₃.

It is optionally provided that, for the production of the slip in the slip production step, between 55 to 65 wt. % ceramic powder, between 24 to 37 wt. % solvent, between 0.28 to 0.38 wt. % dispersing agent, between 3.0 to 5.5 wt. % plasticiser, and between 4.5 to 5.5 wt. % binder are used, wherein the wt. % add up to 100 wt. %. In order to obtain the advantages of the dielectric ceramic film mentioned at the outset, it is particularly advantageous to use the mentioned ratios of the individual components of the slip.

In an alternative embodiment, it is provided that at least polyvinyl butyral is used as the binder. In this case, the binder ensures the particularly advantageous arrangement of the individual particles of the ceramic powder relative to one another. The polyvinyl butyral can furthermore have a different content of polyvinyl alcohol and polyvinyl acetate. However, a polyvinyl alcohol content of between 18 to 21 wt. % is particularly advantageous, and a polyvinyl acetate content of between 8 and 14 wt. %.

In an alternative embodiment, it is provided that, in the slip production step, the oxides and/or the carbonates undergo heat treatment, in order to obtain anhydrous oxides and/or carbonates. In order to obtain the desired composition of the film in the case of this synthesis of the dielectric ceramic film, it is particularly advantageous if the educts used are weight as exactly as possible in the stoichiometric ratio. Stoichiometric weighing is facilitated in that the oxides and/or carbonates used are used in an anhydrous, and thus precisely defined, state. In this case, an anhydrous state is understood to be a state which does not contain any significant amounts of crystal water (hydrates) in the crystal structure, or oxides and/or carbonate which do not comprise any significant amount of adhering water molecules on the particles of the oxides and/or carbonates. This makes it possible for the oxides and/or carbonates to be able to be weighed in as error-free and stoichiometric a manner as possible, for the synthesis. This is because in particular in the case of long storage of the oxides and/or carbonate under atmospheric air, the oxides and/or carbonate can take up or bind an indeterminate amount of water, which would make weighing according to the invention more difficult due to the change in mass.

A possibility for keeping the oxides and/or carbonates in the anhydrous state in the heat treatment is that of exposing the powders of the oxides and/or carbonates to an elevated temperature over a longer time period, such that adhering water and crystal water is removed from the structure. For constituting the anhydrous oxides, the oxides TiO₂, ZrO₂, Al₂O₃ can be heated for a suitable time period of for example eight hours to a temperature of 800° C., and Bi₂O₃ to a temperature of 300° C. The carbonate Na₂CO₃ can be treated for twenty hours at a temperature of 300° C.-200° C. for BaCO₃ and CaCO₃, in order to achieve a transformation into the anhydrous form. In all constitutions of the anhydrous oxides and/or carbonate, it is furthermore irrelevant whether the temperature is elevated in the context of a temperature ramp, before the desired final temperature is reached, or whether the oxides and/or carbonates are treated directly with the desired temperature in a pre-heated furnace.

Preferably, the now anhydrous carbonates and/or oxides are used directly for the synthesis after drying, or they are stored in an anhydrous atmosphere before they are used for the synthesis. If the oxides and/or carbonates are not used directly for the synthesis, but rather precursors thereof, these can also be transferred into an anhydrous form in the context of heat treatment. Alternatively, anhydrous variants of the oxides and/or carbonates can also be constituted in that suitable precursors are converted into oxides and/or carbonate in the context of the heat treatment, wherein they accumulate anhydrously.

Furthermore, the ceramic powder and the organic medium can be ground in the slip production step to form a slurry. For this purpose, the ceramic powder and the organic medium can be ground to the slurry in a ball mill. The mixing of the ceramic powder and the organic medium can take place before addition to the ball mill, or only in the ball mill. Grinding the components in the ball mill makes it possible to achieve a particularly find grinding and thus a small particle size of the ceramic powder, and an optimum and homogeneous mixing, which leads to a high degree of purity of the end product.

In an alternative embodiment, it is provided that the slip is cast in the film-casting step onto a biaxially oriented polyester film. A biaxially oriented polyester film is understood to be a polyester film primarily of polyethylene terephthalate, which is stretched in a longitudinal direction and in a transverse direction extending transversely to the longitudinal direction. A polyester film configured in this way makes it possible for the polyester film, due to the stretching process, to be particularly tear-resistant, smooth, and nonetheless flexible, as a result of which the slip can be cast easily onto the polyester film. For this purpose, the slip can be applied to the polyester film in the desired thickness by means of a suitable method, for example the “doctor blade process”. After the casting of the films, the films can be removed from the polyester film and further processed. Tests have shown that for this purpose in particular a Mylar® film is advantageous as the biaxially oriented polyester film.

It is furthermore provided that the slip undergoes heat treatment in a drying step that follows the film-casting step, in order to remove volatile organic media from the structure, before the sintering step is performed. Heat treatment before the actual sintering step, in which the slip is sintered to form the dielectric ceramic film, offers the advantage that volatile components of the organic medium and also other volatile components such as residual amounts of water can be removed from the structure and thus from the slip. In this case, care should be taken that no actual sintering of the slip takes place in this heat treatment step. Volatile components of the organic medium are the mentioned residual amounts of water, which are present either in the ceramic powder and/or in the solvents used, the plasticisers, the dispersing agent, or the binder.

Particularly advantageously, the volatile components of the slip are removed from the structure slowly and uniformly in the context of the heat treatment. For this purpose, the cast film can be exposed to room temperature or a slightly elevated temperature, which is advantageously increased in a ramp from room temperature to the desired final temperature of the heat treatment, such that no sudden swelling or gas formation of the volatile components occurs, which could in turn result in destruction of the already cast film. The removal of volatile components can also take place at the start of the sintering process. For this purpose, the temperature curve during the sintering process can stay at a plateau, or the removal of volatile organic components can take place directly during a possibly extended heating process.

It is furthermore provided that the electrode is printed onto the cast film in the electrode-application step. Printing on the electrodes allows for simple attachment of the electrodes onto the cast film and/or onto the dielectric ceramic film. In this case, the printing on can take place by machine or by hand.

It is furthermore provided that, in a stacking step, a plurality of cast films, each provided with an electrode, are stacked one on top of the other, in order to form a multi-layer capacitor element as a component, before the sintering step is carried out. In this case, a multi-layer capacitor element is understood to be an element which consists of a plurality of dielectric ceramic films provided with an electrode, which are stacked one above the other in one direction, such that an alternating sequence of an electrode and a dielectric ceramic film results.

In this case, the stacked cast films, provided with an electrode, can be subjected to pressure and pre-pressed before the actual sintering step itself. This can take place for example at a single-digit kN pressure for a few seconds, before the films are optionally pressed by cold isostatic pressing at elevated pressure. In this way, an optimum attachment of the individual films to one another, and between the electrodes and the cast films, can be achieved.

In an alternative embodiment of the method according to the invention, it is provided that the stacked films are exposed to a pressure during the sintering step, in order to counter swelling of the cast films. In addition to the volatile components of the organic medium in the drying step, in the sintering step the remaining components of the organic medium can be burned out of the structure. In this case, the burning out can take place directly during the sintering step or also before the actual sintering step in a burning-out step at elevated temperatures, wherein the temperatures, however, do not yet allow any sintering of the cast films. Additional ceramic powder can be added to the sintering step, in order to counter excessive degassing of volatile components at elevated temperatures.

In order to counter sudden swelling of the cast films, it is advantageous if the temperature is brought in a stepwise manner from room temperature to the desired final temperature, in order to counter sudden evaporation of organic components or remaining water from the structure. In addition, it may be advantageous to apply a pressure to the films during the sintering step, in order on the one hand to retain the original shaping of the film, and on the other hand to counter swelling.

It is optionally provided that the sintering step is performed before the stacking step, wherein in the stacking step a plurality of dielectric ceramic films provided with an electrode are stacked one on top of the other, in order to form a multi-layer capacitor element as a component. In addition to the procedure already discussed, whereby the cast films, each provided with the electrode, are first stacked and subsequently undergo a sintering process in which the cast films are sintered to form a dielectric ceramic film, it is also envisaged according to the invention that firstly, in a performed sintering step, individual cast films provided with an electrode are sintered to form the dielectric ceramic film, before these are stacked to form a multi-layer capacitor element.

This object mentioned at the outset is also achieved by a slip for producing a dielectric ceramic film, wherein the organic medium has at least one solvent which contains at least 1-butanol, at least one plasticiser which contains at least acetyl tributyl citrate, at least one dispersing agent, and at least one binder. An organic medium composed in this way allows, in combination with the ceramic powder, a slip which can be used in a particularly suitable manner for the synthesis of a dielectric ceramic film which comprises at least (1−x)[0.8 (0.94 Na_{0.5}Bi_{0.5}TiO₃·0.06 BaTiO₃)·0.2 CaZrO₃]·x BiAlO₃, where x=0.5, 1, 1.5, 2, 4 and 8 mol %. Particularly advantageously, a slip of this kind can be used for producing a capacitor element comprising a dielectric ceramic film according to any of claims 1 to 10.

It is optionally provided that the slip comprises between 55 to 65 wt. % ceramic powder, between 24 and 37 wt. % solvent, between 0.28 to 0.38 wt. % dispersing agent, between 3 and 5.5 wt. % plasticiser, and between 4.5 to 5.5 wt. % binder, wherein the wt. % add up to 100 wt. %. In order to obtain the advantages of the dielectric ceramic film mentioned at the outset, it is particularly advantageous to use a slip made of the mentioned ratios according to the invention of the individual components of the slip.

According to an alternative embodiment, it is provided that the at least one binder comprises polyvinyl butyral. In this case, the polyvinyl butyral can function on the one hand as a binder and on the other hand also as a dispersing agent.

The object stated at the outset is also achieved by a capacitor element comprising a dielectric ceramic film, in which the slip is constituted according to the disclosure. The slip according to the disclosure allows for a capacitor element having particularly advantageous properties.

It is optionally provided that the capacitor element comprises a plurality of dielectric ceramic films each provided with an electrode, in order to form a multi-layer capacitor element as a component.

Further advantageous embodiments of the method for producing a capacitor element comprising a dielectric ceramic film, the slip for producing a dielectric ceramic film, and the capacitor element comprising a dielectric ceramic film, are illustrated on the basis of the following drawings.

### BRIEF DESCRIPTION OF THE DRAWINGS

FIG. 1 schematically shows the method according to the invention for producing a capacitor element comprising a dielectric ceramic film,

FIG. 2 is a modified schematic illustration of the method from FIG. 1 comprising a drying step and a stacking step,

FIG. 3 is a modified schematic illustration of the method from FIG. 2, wherein the sintering step is performed before the stacking step,

FIG. 4 schematically shows the temperature curve during the sintering step,

FIG. 5 schematically shows the temperature curve with the drying step and the sintering step,

FIG. 6 schematically shows the temperature curve, wherein the drying step is performed during the sintering step,

FIG. 7 schematically shows alternating films of a multi-layer capacitor element,

FIG. 8 shows a composition by way of example of the respective fractions in the slip according to the invention,

FIG. 9 shows the microstructure of a multi-layer capacitor element made of dielectric ceramic films and applied electrodes, on the basis of an REM photograph,

FIG. 10 shows the loss factor tan δ as a function of the temperature of the dielectric ceramic film according to the invention, relative to the prior art,

FIG. 11 shows the polarisation as a function of the electric field of the dielectric ceramic film according to the invention, relative to the prior art,

FIG. 12 shows the efficiency of the dielectric ceramic film according to the invention as a function of the electric field, and

FIG. 13 shows the resistance of the composition according to the invention of the dielectric ceramic film to electric fields and temperature.

### DETAILED DESCRIPTION

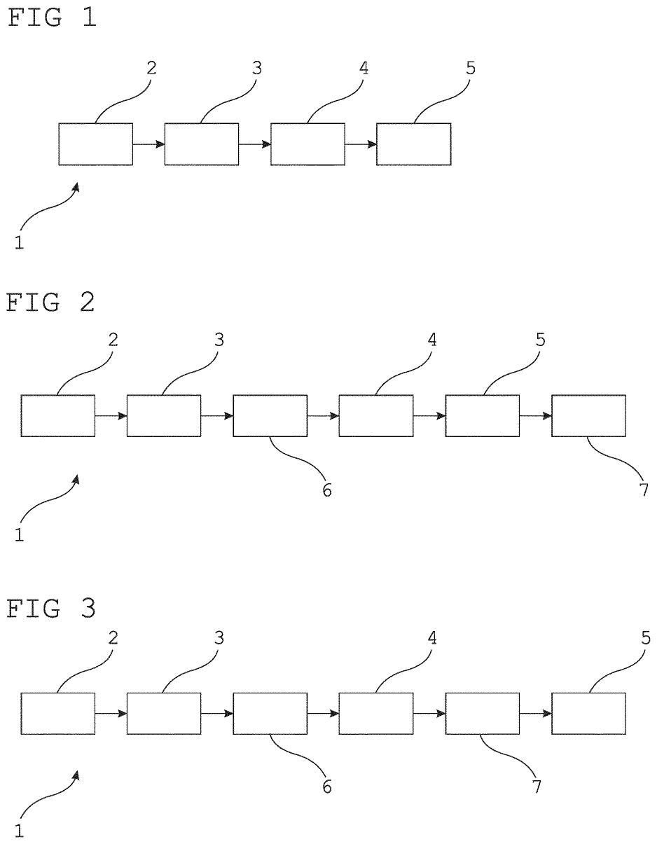

FIGS. 1 to 3 show different embodiments of the method 1 according to the invention for producing a capacitor element comprising a dielectric ceramic film.

In FIG. 1, the method 1 according to the invention for producing a capacitor element comprising a dielectric ceramic film is shown schematically with the individual method steps.

In an initial slip production step 2, a slip composed of the oxides Bi₂O₃, TiO₂, ZrO₂ and Al₂O₃, the carbonates Na₂CO₃, BaCO₃ and CaCO₃, and an organic medium, is produced. In this case, the organic medium comprises 1-butanol as the liquid solvent, acetyl tributyl citrate as the plasticiser, a dispersing agent, and a binder. The ceramic powder and the organic medium are mixed together in the slip production step and ground in a ball mill until a homogeneous slurry results.

In a film-casting step 3 that follows the slip production step 2, the slip is applied to a biaxially oriented polyester film with a film density of preferably 250 μm film density.

Subsequently, the cast film is provided, in an electrode-application step 4, with an electrode composed of a silver/palladium electrode material, wherein the metal content is 55% with a silver/palladium ratio of 70:30. In order to dry the printed electrode, the cast film and the electrode undergo surface drying for 20 minutes at 75° C. in a drying furnace, and are dried at 90° C. by the complete evaporation of solvents and volatile components of the electrode material. After the drying, the cast film comprising the electrodes can be removed from the film.

The film provided with the electrodes is subjected to a pressure, in the sintering step 5, and initially heated from room temperature to a temperature of 600° C. within 20 hours, in order to burn out all the organic components, wherein the temperature is further increased from 600° C., at a heating rate of 5° C./min, to 1100° C., and kept at this temperature for two hours, before cooling to room temperature at a cooling rate of 5° C./min takes place. In said sintering step 5 the slip is sintered, depending on the weighing of the ceramic powder, to (1−x)[0.8 (0.94 Na_{0.5}Bi_{0.5}TiO₃·0.06 BaTiO₃)·0.2 CaZrO₃]·x BiAlO₃, where x=0.5, 1, 1.5, 2, 4 and 8 mol %.

The capacitor element can subsequently be provided, in a following step, with external electrodes and further contacts, in order to form a capacitor from the capacitor element.

In FIG. 2, a modified method 1 for producing a capacitor element comprising a dielectric ceramic film proceeding from FIG. 1 is shown, wherein the method is extended by the method steps of the drying step 6 and stacking step 7.

In the drying step 6, which follows the film-casting step 2, the cast film undergoes heat treatment, in order to remove volatile organic media from the structure, before the sintering step 5 is performed. This makes it possible to remove volatile components of the organic medium and also other volatile components such as residual amounts of water from the structure and thus from the slip, which components could lead, in the case of sudden evaporation, to bursting of the slip film in the sintering step 5.

In order produce a multi-layer capacitor element, a plurality of cast films provided with an electrode are stacked one on top of the other, in the stacking step, to form a stack. A multi-layer capacitor element is understood to be an element which consists of a plurality of ceramic films provided with an electrode, which are stacked one above the other in one direction, such that an alternating sequence of an electrode and a dielectric ceramic film results. In this case, the stacking step 7 is performed after the electrode-application step 4 and before the sintering step 5.

The stack of alternating cast films and electrodes is subjected to a pressure and pre-pressed at 6 kN. The stack subsequently undergoes cold isostatic pressing in an oil bath at 153 MPa and is laminated, in order to allow for optimum attachment of the individual films to one another, and between the films and the electrodes. The stack pressed in this way is now placed in a ceramic crucible between two aluminium oxide foam plates. Additional sacrificial powder from the ceramic powder prevents excessive degassing of volatile components of the ceramic at elevated temperatures. Subsequently, the sintering step 5 is performed as described above.

FIG. 3 shows the method 1 according to the invention from FIG. 2, wherein the sintering step 5 is carried out before the stacking step 7.

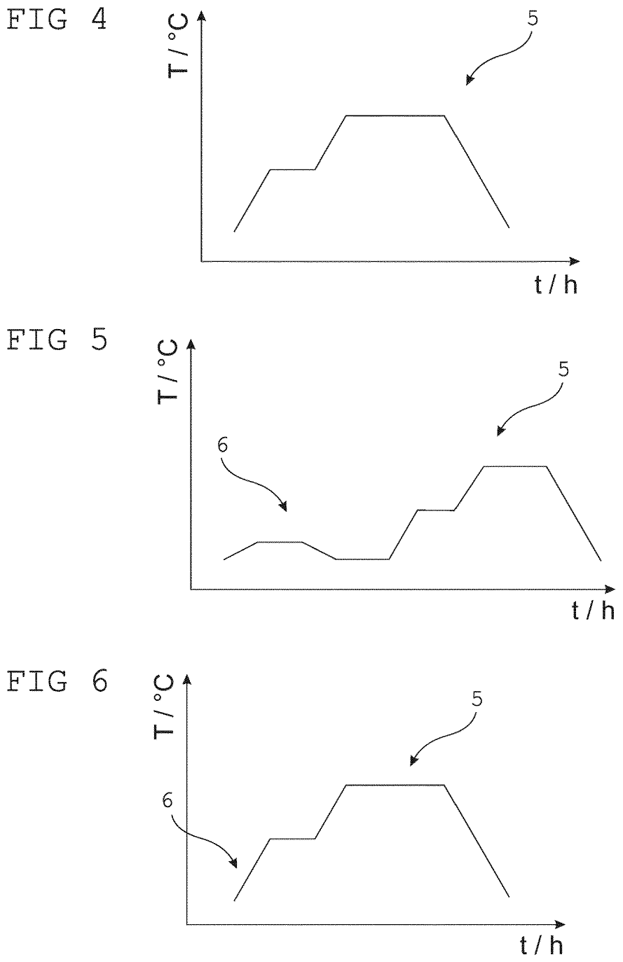

FIGS. 4 to 6 each show different variants according to the invention of the temperature programme during the production of the dielectric ceramic film. In this case, the temperature programme in each case shows the curve of the temperature as a function of time. In this case, the graphs shown are intended merely to symbolise the temperature curve and are not shown true to scale.

FIG. 4 shows the temperature programme during the sintering step 5. In this cast, the cast film and the applied electrodes or the stack are initially heated from room temperature to a temperature of 600° C. within 20 hours, in order to burn out all the organic components, wherein the temperature is further increased from 600° C., at a heating rate of 5° C./min, to 1100° C., and kept at this temperature for two hours, before cooling to room temperature at a cooling rate of 5° C./min takes place.

FIG. 5 shows the temperature curve of the method 1 shown in FIG. 2, consisting of the drying step 6 and the subsequent sintering step 5, while in FIG. 6 the drying step 6 is a part of the sintering step 5.

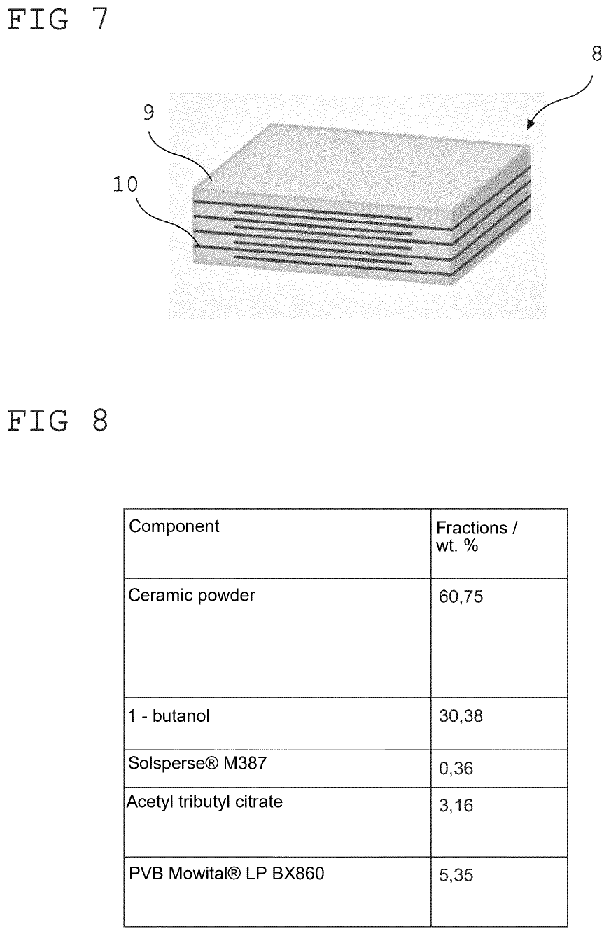

FIG. 7 schematically shows the multi-layer capacitor element 8. In this case, the multi-layer capacitor element 8 comprises an alternating sequence of dielectric ceramic films 9 and electrodes 10 therebetween.

FIG. 8 shows a composition by way of example of the fractions in the slip according to the invention. In this case, the slip comprises 60.75 wt. % ceramic powder, 30.38 wt. % 1-butanol, 0.36 wt. % Solsperse M387 as the dispersing agent, 3.16 wt. % acetyl tributyl citrate as the plasticiser, and 5.35 wt. % PVB Mowital LP BX860 as the binder. The dielectric ceramic film 9 having this composition surprisingly exhibits optimal properties and is therefore suitable in particular for use at high temperatures, significant temperature fluctuations, and high applied electric fields. The dielectric ceramic film exhibits a stable relative permittivity within −83° C. to 550° C., having a fluctuation of ≤15% and a maximum value of 630 at 1 KHz.

The dielectric loss tan δ≤0.02 in the high temperature range is stable in a between −68° C.-391° C. This results in a maximum range of use of −68° C.-391° C. for use of the material as a capacitor element or as a multi-layer capacitor element.

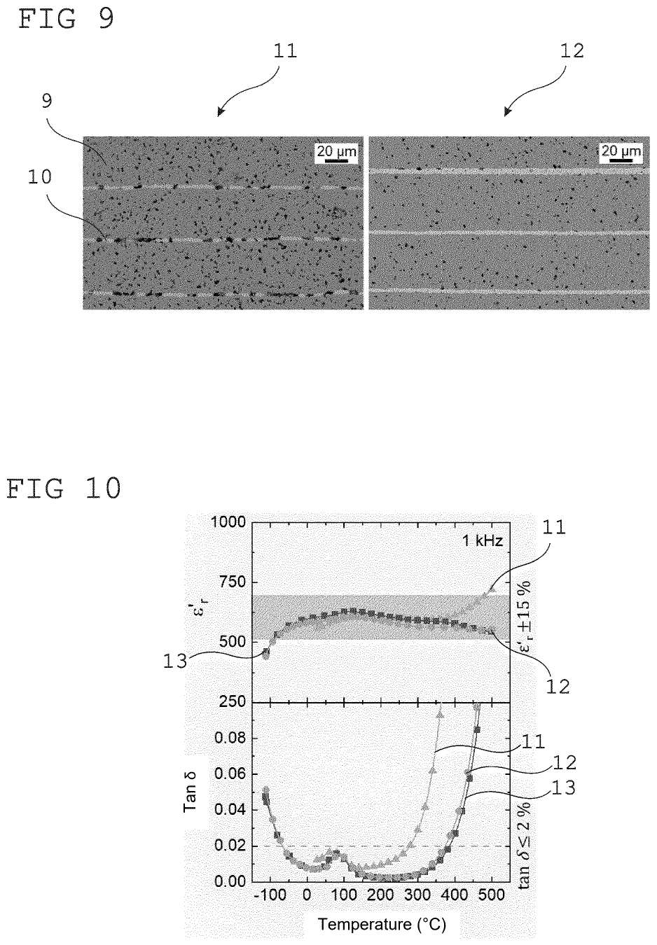

FIG. 9 shows the microstructure of a multi-layer capacitor element 8 made of dielectric ceramic films 9 and applied electrodes 10 in the prior art 11 and of the composition according to the invention of the dielectric ceramic film 12, on the basis of an REM photograph. In this case, in particular a more homogeneous structure can be seen, as well as an improved density compared with the prior art 11, which results in the above-mentioned advantages.

FIG. 10 shows the temperature resistance of the composition according to the invention of the dielectric ceramic film 12 compared with a reference material 13 (Hoang, A. P., Steiner, S., Yang, F., Li, L., Sinclair, D. C., & Frömling, T. (2021), Journal of the European Ceramic Society, 41(4), 2587-2595) and compared with the prior art 11. In this case, the permittivity and the loss factor tan δ are plotted as a function of the temperature. In this case, the composition according to the invention of the dielectric ceramic film results in particular in the high temperature range in a lower dielectric loss compared with the prior art 11, as a result of which the dielectric properties in the selected temperature range are virtually identical.

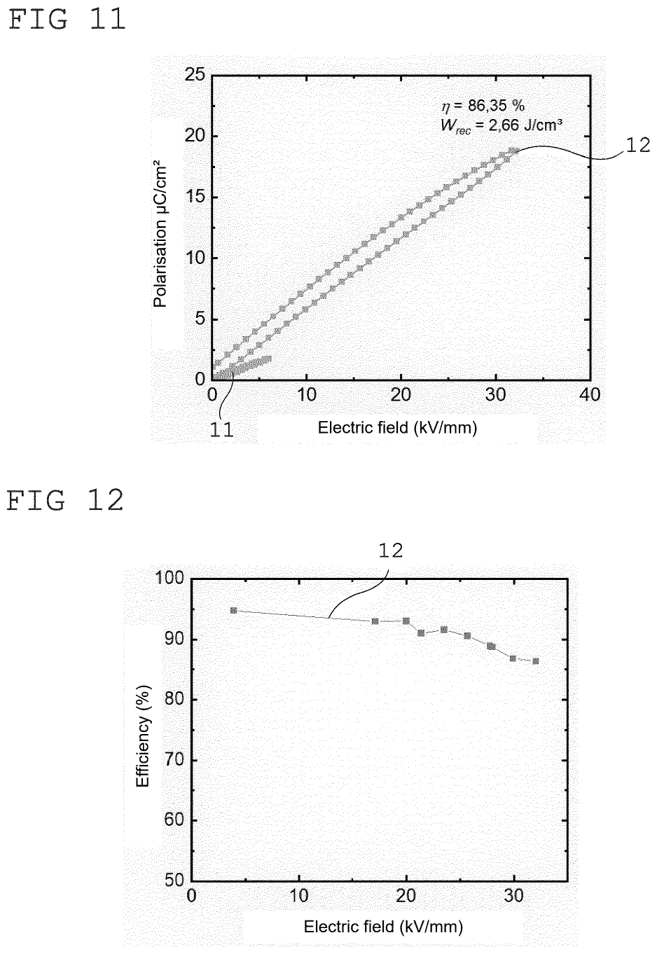

FIGS. 11 and 12 show further advantageous properties of a capacitor element proceeding from the slip composition according to the invention. FIG. 11 shows the polarisation of the ceramic dielectric film 12 against the applied electric field, while FIG. 12 shows the effectiveness of the polarisation process depending on the electric field. In this case, it was possible to achieve very high energy storage densities, compared with competitor technologies, of 2.66 J/cm³ (at 32 kV/mm), and an efficiency of >86% throughout.

As a result, the capacitor element and the multi-layer capacitor element 8 are suitable for being used as a surge protector or intermediate circuit capacitor and thus to absorb voltage peaks or keep voltages constant. In particular the applied electric field of 32 kV/mm impressively shows the reliability in the high voltage region.

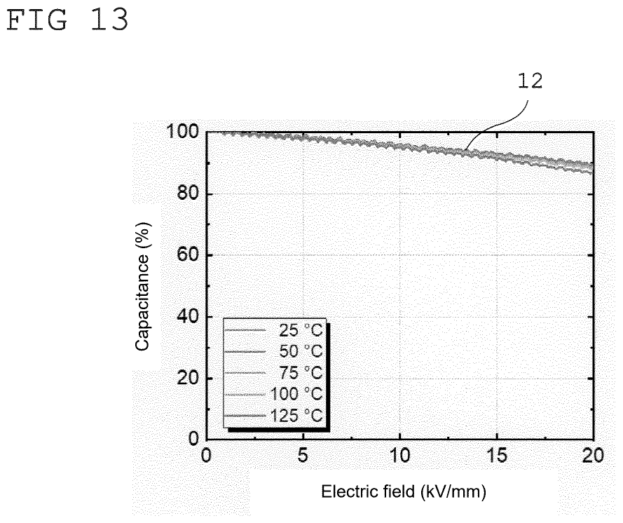

FIG. 13 shows the resistance of the composition according to the invention of the dielectric ceramic film 12 to electric fields and temperature. In this case, the capacitance is plotted against the electric field and different temperatures from 25° C. to 125° C. Changes of at most approximately 13% in the case of a field of 20 kV/mm and a simultaneously prevailing temperature of 125° C. impressively show the stability, with respect to both factors, of the composition according to the invention of the dielectric ceramic film 12.

### LIST OF REFERENCE SIGNS

1 method for producing a capacitor element
2 slip production step
2 film-casting step
4 electrode-application step
5 sintering step
6 drying step
7 stacking step
8 multi-layer capacitor element
9 dielectric ceramic film
10 electrode
11 prior art
12 composition according to the invention of the dielectric ceramic film
13 reference

1.-16. (canceled)

17. A method (1) for producing a capacitor element comprising a dielectric ceramic film (9), the method comprising:
producing, in a slip production step (2), a slip from a ceramic powder and an organic medium,
wherein the ceramic powder comprises
oxides, including at least Bi₂O₃, TiO₂, ZrO₂, and Al₂O₃, or precursors thereof, and
carbonates, including at least Na₂CO₃, BaCO₃, and CaCO₃, or precursors thereof,
in a stoichiometric ratio in order to synthesize (1−x)[0.8 (0.94 Na_{0.5}Bi_{0.5}TiO₃·0.06 BaTiO₃)·0.2 CaZrO₃]·x BiAlO₃,
where x=0.5, 1, 1.5, 2, 4 and 8 mol %;
casting the slip as a film in a film-casting step (3);
applying an electrode (10) to the cast film in an electrode-application step (4); and
sintering the cast film provided with the electrode (10) in a sintering step (5) at an elevated temperature in order to remove organic material from a structure and to convert the cast film into the dielectric ceramic films (9),
wherein the dielectric ceramic film (9) comprises at least (1−x)[0.8 (0.94 Na_{0.5}Bi_{0.5}TiO₃·0.06 BaTiO₃)·0.2 CaZrO₃]·x BiAlO₃, where x=0.5, 1, 1.5, 2, 4 and 8 mol %, and
wherein the organic medium comprises
at least one liquid solvent which contains at least 1-butanol,
at least one plasticiser which contains acetyl tributyl citrate,
at least one dispersing agent, and
at least one binder.

18. The method (1) according to claim 17,
wherein the slip production step (2) comprises using
between 55 to 65 wt. % ceramic powder,
between 24 to 37 wt. % solvent,
between 0.28 to 0.38 wt. % dispersing agent,
between 3.0 to 5.5 wt. % plasticiser, and
between 4.5 to 5.5 wt. % binder,
wherein at total wt. % thereof add up to 100 wt. %.

19. The method (1) according to claim 17,
wherein the binder comprises polyvinyl butyral.

20. The method (1) according to claim 17,
wherein the slip production step (2) includes subjecting the oxides and/or the carbonates to heat treatment, in order to obtain anhydrous oxides and/or carbonates.

21. The method (1) according to claim 17,
wherein the slip production step includes grinding the ceramic powder and the organic medium in (2) to form a slurry.

22. The method (1) according to claim 17,
wherein the film-casting step (3) includes casting the slip in onto a biaxially oriented polyester film.

23. The method (1) according to claim 17, further comprising:
subjecting the slip to heat treatment in a drying step (6) that follows the film-casting step (3), in order to remove volatile organic media from the structure, before the sintering step (5) is performed.

24. The method (1) according to claim 17,
wherein the electrode-application step (4) includes printing the electrode (10) onto the cast film in.

25. The method (1) according to claim 17, further comprising
stacking, in a stacking step (7) before the sintering step (5) is carried out, a plurality of cast films, each provided with an electrode (10), one on top of another, in order to form the capacitor element as a multi-layer capacitor element (8).

26. The method (1) according to claim 25, further comprising:
exposing the stacked films to a pressure during the sintering step (5), in order to counter swelling of the cast films.

27. The method (1) according to claim 17,
wherein the sintering step (5) is carried out before a stacking step (7),
wherein in the stacking step (7) a plurality of dielectric ceramic films (9), each provided with an electrode (10), are stacked one on top of the other, in order to form the capacitor element (8) as a multi-layer capacitor element (8).

28. A slip for producing a dielectric ceramic film (9), comprising:
a ceramic powder; and
an organic medium,
wherein the ceramic powder comprises
oxides, including at least Bi₂O₃, TiO₂, ZrO₂, and Al₂O₃, or precursors thereof, and carbonates, including at least Na₂CO₃, BaCO₃, and CaCO₃, or precursors thereof, and
wherein the organic medium comprises
at least one solvent which comprises at least 1-butanol,
at least one plasticiser which comprises at least acetyl tributyl citrate,
at least one dispersing agent, and
at least one binder.

29. The slip according to claim 28, wherein the slip comprises
between 55 to 65 wt. % ceramic powder,
between 24 to 37 wt. % solvent,
between 0.28 to 0.38 wt. % dispersing agent,
between 3.0 to 5.5 wt. % plasticiser, and
between 4.5 to 5.5 wt. % binder,
wherein a total wt. % thereof add up to 100 wt. %.

30. The slip according to claim 28,
wherein the at least one binder comprises polyvinyl butyral.

31. A capacitor element comprising
a dielectric ceramic film (9) which comprises at least (1−x)[0.8 (0.94 Na_{0.5}Bi_{0.5}TiO₃·0.06 BaTiO₃)·0.2 CaZrO₃]·x BiAlO₃,
where x=0.5, 1, 1.5, 2, 4 and 8 mol %,
wherein the dielectric ceramic film (9) comprises an electrode (10), and
wherein the ceramic film (9) is produced from a slip,
wherein the slip comprises a ceramic powder and an organic medium, and
wherein the slip is constituted according to claim 17.

32. The capacitor element according to claim 31,
wherein the capacitor element comprises a plurality of dielectric ceramic films (9) provided with an electrode (10).
